(19) United States
(12) Patent Application Publication
(10) Pub. No.: US 2002/0187217 A1
(43) Pub. Date: Dec. 12, 2002

(54) Injection molding cooling core and method of use

(76) Inventors: Robert R. McDonald, Traverse City, MI (US); William O. Jones, Traverse City, MI (US)

Correspondence Address: REISING ETHINGTON BARNES KISSELLE, LEARMAN AND MCCULLOCH PC, P O BOX 4390, TROY, MI, 48099-4390, US

(21) Appl. No.: 09/947,857

(22) Filed: Sep. 6, 2001

Related U.S. Application Data
(60) Provisional application No. 60/232,300, filed on Sep. 12, 2000.

(51) Int. Cl. B29C 45/72

(52) U.S. Cl. 425/547

(57) ABSTRACT

An injection molding cooling core 10 comprises an elongated, hollow core pin 15 having an inner surface 16 and an outer surface 17. The core pin 15 is open at one end, and has an end cap 18 at an opposite end. The core 10 also has an elongated, hollow insert 20 having an inside surface 21 and an outside surface 22. The insert 20 has a plurality of protrusions 25 on the outside surface 22, which extend radially outwardly from the insert 20. The insert 20 is designed to fit within the core pin 15 whereby the protrusions 25 contact the inner surface 16 of the core pin 15. The protrusions 25 are metallurgically joined to the core pin 15 whereby there is a continuous metallurgical path for heat transfer between the outer surface 17 of the core pin 15 and the insert 20. The protrusions 25 also provide strength to the core pin 15 and a greatly enhanced heat transfer surface.

The inside surface 21 of the hollow insert 20 defines a conduit for a heat exchanging fluid 29. The heat exchanging fluid 29 flows in a direction from the open end of the core pin 15, through the hollow insert 20, towards the end cap 18, exiting the hollow insert 20 near the end cap 18 and contacting the end cap 18, then flowing between the outside surface 22 of the insert 20 and the inner surface 16 of the core pin 15. The heat exchanging fluid 29 further achieves turbulent flow around the protrusions 25, then flows out of the open end of the core pin 15, thus providing heat transfer to or from the outer surface 17 of the core pin 15.

### CROSS-REFERENCE TO RELATED APPLICATION

This application makes reference to provisional application 60/232,300 filed on Sep. 12, 2000.

### TECHNICAL FIELD

The present invention relates to the construction and method of using forming tools for use in shaping articles of manufacture and more particularly to injection molding cooling cores having heat-exchanging characteristics.

### BACKGROUND OF THE INVENTION

Forming tools, such as metal molds and dies, are employed in many processes to impart a desired shape to an article of manufacture. For example, metal molds and dies are used to produce cast metal articles having the shape of the casting cavity of the tool. In the plastics and glass making industry metal dies are used to shape various plastics, resins, composites, and glass to produce various shaped articles from these materials.

In many of these forming operations, such as for example the casting of molten metal or the molding of hot plastics or glass, there is a considerable amount of heat that must be dissipated in order to cool the article sufficiently to render the material from which the article is made form stable, allowing it to be released from the forming tool. It is of course desirable in many of these operations that the heat be dissipated as quickly as possible since often the rate limiting step of a given forming cycle is the time it takes to extract the heat from the article. As such, heat transfer efficiency and thermal control of the forming tool used to shape the articles are key to the product quality and manufacturing economics of the articles made from the tools. In addition to these advantages, a high efficiency forming tool reduces tooling and manufacturing costs as fewer tools are needed to support a given production schedule.

In accordance with one known practice, the manufacture of a forming tool, such as a metal mold, begins with a solid block of metal into which a contoured shaping surface is machined having a configuration corresponding to the shape to be imparted to the article being formed by the tool.

In an effort to improve the heat-transfer efficiency of the solid metal mold, it is common to bore fluid passages into the mold beneath the shaping surface through which water, gas or other heat-transferring fluids may be passed to draw heat from the mold tool and hence the article. The drilling of cooling passages, however, adds to the time and cost of making the tool and further is limited in its effectiveness since it is not always practical or possible to extend the passages into all areas of the mold where they are required in order to achieve the desired cooling characteristics. Inadequate or nonuniform cooling of the forming tool may distort the desired shape of the article made by the tool.

There are several U.S. patents which disclose cooled mold cores. Some of the more closely related are detailed below:

U.S. Pat. No. 5,746,966, which is commonly assigned to the assignee of the present invention and the disclosure of which is hereby incorporated by reference, is directed to molds, dies or forming tools having..a cavity formed by thermal spraying and methods of use.

U.S. Pat. No. 5,832,981, which is commonly assigned to the assignee of the present invention, is directed to a heat exchanging cast metal forming tool designed to dissipate heat more efficiently than the traditional approach described above.

U.S. Pat. No. 6,077,067 discloses an injection molding apparatus having a cooling core with a ribbed cap. U.S. Pat. No. 6,079,972 discloses an injection molded cooling core having spiral grooves. While these two patents may constitute a slight improvement over the prior art, they fail to provide a sufficient surface area for the heat transferring fluid to maximize the transfer of heat from the article to be shaped.

A principal object of the present invention is to improve on these early developments in heat-exchanging forming tools, specifically as applied to injection molding techniques.

### SUMMARY OF THE INVENTION

This invention pertains to an injection molding cooling core comprising an elongated, hollow core pin having an inner surface and an outer surface. The core pin is open at one end, and has an end cap at an opposite end. The core also has an elongated, hollow insert having an inside surface and an outside surface. The insert has a plurality of protrusions on the outside surface, which extend radially outwardly from the insert. The insert is designed to fit within the core pin whereby the protrusions contact the inner surface of the core pin. The protrusions are metallurgically joined to the core pin whereby there is a continuous metallurgical path for heat transfer between the outer surface of the core pin and the insert. The protrusions also provide strength to the core pin. By protrusions we mean any protuberance, bump, bulge or swelling, whether regular or irregular, which extends beyond the plane of the outer surface of the core pin insert.

The protrusions are also designed to greatly increase the surface area for enhanced heat transfer within the core pin. Further, the protrusions are designed and placed in a staggered array (or alternatively a designed disarray) to force the maximum amount of turbulence in the flow of the heat transfer fluid.

In addition, although the increased inner surface area is important the velocity of the heat transfer fluid is as important. For a given pressure drop through the core pin body, the better balance in the improvement in heat transfer performance is achieved by selecting a narrower gap between the inner wall of the core pin and the outer surface of the insert. Thus the shorter protrusions and the narrow gap force a higher velocity to the heat transfer fluid and a higher transfer of heat occurs.

The inside surface of the hollow insert defines a conduit for a heat exchanging fluid. The heat exchanging fluid flows in a direction from the open end of the core pin, through the hollow insert, towards the end cap, exiting the hollow insert near the end cap and contacting the end cap, then flowing between the outside surface of the insert and the inner surface of the core pin. The heat exchanging fluid further achieves turbulent flow around the protrusions, then flows out of the open end of the core pin, thus providing heat transfer to or from the outer surface of the core pin. Alternately, the fluid could be made to flow in a direction opposite to that just described.

This invention also pertains to an injection molding cooling core comprising an elongated, hollow core pin having an inner surface and an outer surface. The core pin is open at one end, and has an end cap at an opposite end. The core pin has a plurality of protrusions extending radially from the inner surface towards the axis of the core pin. The core also has an elongated hollow bubbler tube having an inside surface and an outside surface. The bubbler tube is press fit into the core pin whereby the protrusions on the inside surface of the core pin wall contact the outside surface of the bubbler tube thus providing strength to the cooling core pin.

The inside surface of the hollow bubbler tube defines a conduit for a heat exchanging fluid. The heat exchanging fluid flows in a direction from the open end of the core pin, through the bubbler tube, towards the end cap, exiting the bubbler tube near the end cap and contacting the end cap, then flowing between the outside surface of the insert and the inner surface of the core pin. The heat exchanging fluid further achieves turbulent flow around the protrusions, then flows out of the open end of the core pin, thus providing heat transfer to or from the outer surface of the core pin. Alternately, the fluid could be made to flow in a direction opposite to that just described.

The protrusions are also designed to greatly increase the surface area for enhanced heat transfer within the core pin. Further, the protrusions are designed and placed in a staggered array (or alternatively a designed disarray) to force the maximum amount of turbulence in the flow of the heat transfer fluid.

In addition, although the increased inner surface area is important the velocity of the heat transfer fluid is as important. For a given pressure drop through the core pin body, the better balance in the improvement in heat transfer performance is achieved by selecting a narrower gap between the inner wall of the core pin and the outer surface of the insert. Thus the shorter protrusions and the narrow gap force a higher velocity to the heat transfer fluid and a higher transfer of heat occurs.

Lastly, this invention pertains to a method of using the injection molding cooling cores described above comprising the steps of: providing a mold having a molding surface; inserting either of the injection molding cooling cores described above into the mold to define a cavity between the molding surface and the outer surface of the core pin; inserting a material to be molded into the cavity of the mold; molding the product; and recovering the product.

### BRIEF DESCRIPTION OF THE DRAWINGS

Presently preferred embodiments of the invention are disclosed in the following description and in the accompanying drawings, wherein:

FIG. 1 is a perspective view of the insert of a first preferred embodiment of the invention;

FIG. 2 is a perspective view of the injection molding cooling core of a first preferred embodiment of the invention;

FIG. 3 is a cross-section view of the injection molding cooling core of the first preferred embodiment taken substantially along line 3-3 of FIG. 2 looking in the direction of the arrows;

FIG. 4 is a cross-section view of the injection molding cooling core of the first preferred embodiment taken substantially along line 4-4 looking in the direction of the arrows;

FIG. 5 is a perspective view of the injection molding cooling core of a second preferred embodiment on the invention;

FIG. 6 is a side view of the invention inserted into a mold cavity.

### DETAILED DESCRIPTION OF THE PREFERRED EMBODIMENT

The invention relates primarily to a heat exchanging forming tool, and more specifically to an injection molding cooling core used, for example, to mold plastics, glass or metal.

The design of the invention is applicable to all injection molding tooling, but is especially applicable to the core portion of the tooling. This is so because the hot, semi-solid material shrinks onto the core and away from the cavity as the part cools. This behavior means that the majority of the heat in the part is removed through the core. As the part shrinks away from cavity, an insulating air gap is formed between the part and the mold surface, thus reducing the effectiveness of cooling the outer part of the mold.

To achieve major/maximum improvements in heat transfer performance, the key issues to be considered are:

a) A continuous metallurgical path from the molding surface to the internal heat transfer surface to which the heat transfer fluid makes contact must be achieved. [0031] Hence, for the completed preform core pin it is very important to the heat transfer performance to have a metallurgical bond between the body of the core pin and the protrusions of the core insert.

Other designers of bubblers and the like do not suggest how important this factor is to performance.

A discontinuous path (a gap) of 0.0001 ″ or more reduces the heat transfer efficiency (U_{O}) of a molding tool dramatically. The effect is more damaging to performance than one might expect.

b) The molding tool's internal heat transfer surface area that is in contact with the heat transfer fluid must be increased significantly.

By the use of the protrusions on the core insert one is able to increase the surface contact area by 2-4X. For blow molds the increased surface contact area can be up to 15 but the volume within the core body is typically small and limits the increase in U_{O} (heat transfer coefficient) and the attendant improvements.

c) The thermal path length from the molding surface to the internal heat transfer surface is to be minimized and made uniform.

This path length is a resistance to the flow of thermal energy so one wants to limit the path length. This is done by thinning the wall of the core body. But, there are mechanical limitations to this action. The preform core must stand up to the compressive forces that occur during the injection molding of the plastic.

Hence, the structural support for the core body wall that is provided by the structure i.e., the protrusions of the insert, permits one to thin the core body wall.

The structure i.e., protrusions, must therefore be intimate and/or bonded to the core body wall so as to provide internal structural support for the molding tools molding surface.

d) The maximum heat transfer performance of the mold, for all designs, is achieved by the use of materials of construction having the highest thermal conductivity consistent with all other factors.

Hence, the choice of alloy is inter-related with several design factors, namely:

the desire to use a high thermally conductive alloy to achieve the maximum heat transfer performance,

the strength needed to support a thinner core body wall, and

the corrosion and fouling characteristics based on the quality of the heat transfer fluid.

e) The heat transfer fluid must be forced into turbulent flow as it moves through the molding tool body so as to achieve the highest possible heat transfer performance for any given molding tool.

Thus the protrusions of the core insert are typically located as a defined, staggered array or alternately in a defined disarray, such that the heat transfer fluid flow must flow via a tortuous path through the tool; the fluid is forced to continually change direction and cause intensive mixing of the heat transfer fluid.

Whereas water has an excellent heat capacity, it does not conduct heat well when stagnant or in laminar flow. The stirring due to the staggered array of protrusions, or other impediments, forces mixing and results in improved heat transfer.

The invention is applicable with respect to the injection molding of thermoplastic materials, preferably polyethylene terephthalate (PET) bottle preforms. However, it applies equally well to the injection molding of bottle preforms with any single plastic material, such as oxygen barrier polymers. It would also apply to the injection molding of bottle preforms with any combination of co-extruded, multi-layer plastic material. It applies to any preform, including those used for food and/or drug storage. The invention is primarily but not exclusively applicable for molding tool where the ratio of core depth to core diameter is greater than one.

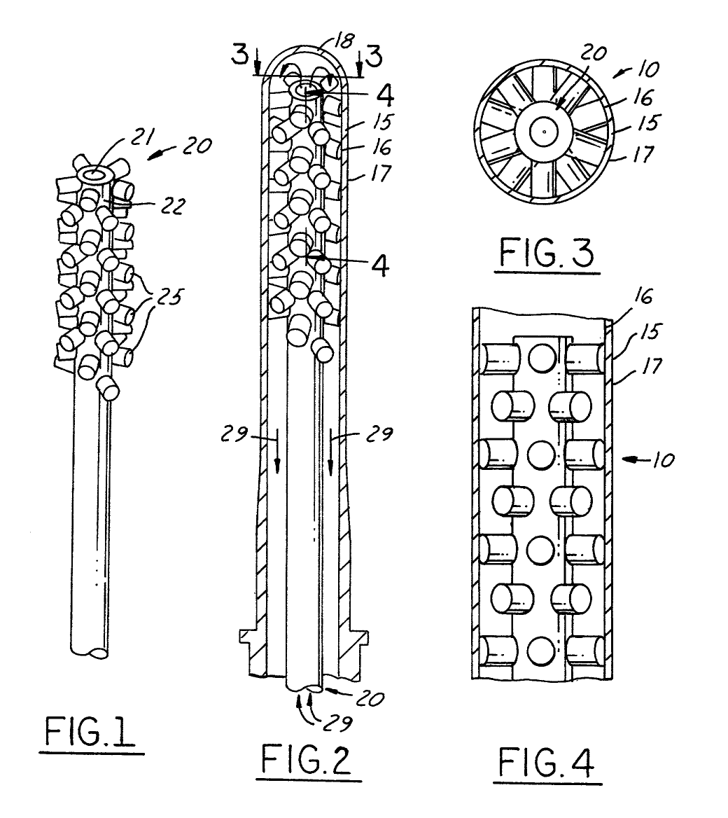

FIGS. 1 through 4 show a first embodiment of the claimed invention. An injection molding cooling core 10 comprises an elongated, hollow core pin 15 having an inner surface 16 and an outer surface 17. The core pin 15 is open at one end, and has an end cap 18 at an opposite end. The core 10 also has an elongated, hollow insert 20 having an inside surface 21 and an outside surface 22. The insert 20 has a plurality of protrusions 25 on the outside surface 22, which extend radially outwardly from the insert 20. The insert 20 is designed to fit within the core pin 15 whereby the protrusions 25 contact the inner surface 16 of the core pin. The protrusions 25 are metallurgically joined to the core pin 15, best shown in FIG. 3, whereby there is a continuous metallurgical path for heat transfer between the outer surface 17 of the core pin 15 and the insert 20. This metallurgical joining could be accomplished, for example, by inserting the insert 20 into the core pin 15 and then heating to a sufficient temperature to metallurgically join (e.g., via brazing, soldering, diffusion bonding or the like) the protrusions 25 to the inside surface 16 of the core pin 15. This metallurgical joining allows the protrusions 25 to provide strength to the core pin 15; and also provides for a substantially uniform cooling of the surface 17 of the core pin 15.

The inside surface 21 of the hollow insert 20 defines a conduit for a heat exchanging fluid 29. The heat exchanging fluid 29 flows in a direction from the open end of the core pin 15, through the hollow insert 20, towards the end cap 18, exiting the hollow insert 20 near the end cap 18 and contacting the end cap 18, then flowing between the outside surface 22 of the insert 20 and the inner surface 16 of the core pin 15. The heat exchanging fluid 29 further achieves turbulent flow around the protrusions 25, then flows out of the open end of the core pin 15, thus providing heat transfer to or from the outer surface 17 of the core pin 15.

Note that while FIGS. 1-4 show five protrusions 25 in a plane around the insert 20, as few as three or as many as eight or ten could be used. Likewise, while the Figures show the protrusions as being substantially rounded pegs of uniform diameter, the invention is not limited to such design. Protrusions of many different shapes will work. It is also understood that the cross section of the protrusion does not necessarily have to be uniform. The end cap 18 may also take on any shape necessary depending on the article to be molded and the material to be used.

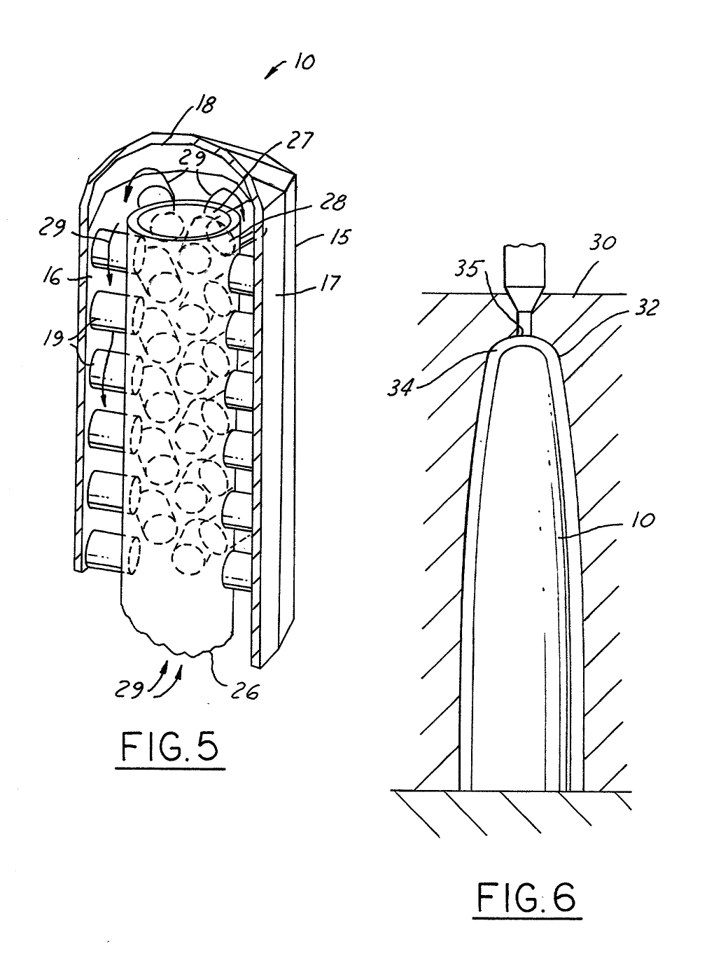

FIG. 5 shows a second preferred embodiment of the claimed invention. An injection molding cooling core 10 comprises an elongated, hollow core pin 15 having an inner surface 16 and an outer surface 17. The core pin 15 is open at one end, and has an end cap 18 at an opposite end. The core pin 15 has a plurality of protrusions 19 extending radially from the inner surface 16 towards the axis of the core pin 15. The core 10 also has an elongated, hollow bubbler tube 26 having an inside surface 27 and an outside surface 28. The bubbler tube 26 is press fit in the core pin 15 whereby the protrusions 19 contact the outside surface 28 of the bubbler tube 26, thus providing strength to the cooling core 10.

The inside surface of the bubbler tube 26 defines a conduit for a heat exchanging fluid 29. The heat exchanging fluid 29 flows in a direction from the open end of the core pin 15, through the bubbler tube 26, towards the end cap 18, exiting the bubbler tube 26 near the end cap 18 and contacting the end cap 18, then flowing between the outside surface 28 of the bubbler tube 26 and the inner surface 16 of the core pin 15. The heat exchanging fluid 29 further achieves turbulent flow around the protrusions 19, then flows out of the open end of the core pin 15, thus providing heat transfer to or from the outer surface 17 of the core pin 15.

In order to achieve the greatest amount of thermal energy transfer, the core pin 15 should be manufactured from a material which transfers heat efficiently, however substantial improvements in thermal energy transfer can be achieved by using the core pins as described in this invention made from other materials such as stainless steels, tool steels, titanium alloys, nickel alloys, and the like or other alternative engineering materials. A preferred material for the core pin 15 is a copper beryllium alloy. A preferred content of beryllium is about 2%. In the second preferred embodiment, where the protrusions 19 are an integral part of the core pin 15, a stainless steel bubbler tube 26 is preferred, as this gives added strength to the cooling core 10.

The cooling core 10 of the present invention can be used in molds for a variety of end uses. A preferred use is the application of the cooling core 10 in a mold 30 in the formation of plastic products. The plastic used should be capable of being injection molded, but may also be used in a RIM (reaction injection molding) process. The plastic materials may be thermoplastic materials, such as those that soften upon the application of temperature and upon cooling conform to a new shape. A subsequent application of heat would allow the material to take on a new shape as desired. Alternately, a thermoset material could be used. Thermoset-materials are those that set with application of temperature and/or pressure and/or catalysts to a fixed and firm position. A subsequent application of heat does not permit deformation, but rather destruction, of the bonds involved in the formation of the thermoset final products.

Examples of thermoplastic materials are polystyrene, acrylonitrile, styrene acrylonitrile, polyvinyl chloride (PVC), polyethylene terephthalate (PET), polysulfone, polyethylene, polypropylene, high density and (very) low density polyethylene materials, nylon materials, polyamides, oxygen barrier materials such as PET, PVDC (polyvinyl dichloride), polytetrafluoroethylene (PTFE), polyvinylidene chloride, polypropylene, polybutylene, polyisobutylene, and the like. Thermoset materials may be such materials as epoxy materials, polyurethane materials, polyester materials, polyacetates, polycarbonates, poly(methyl)methacrylates and the like. Also to be contemplated as plastic materials would be elastomeric materials such as rubber or synthetic rubber materials, styrene butadiene, isopropylene, and the like.

In general, to utilize lightweight molds for the thermal application of thermoset materials, the desired characteristics of the tooling would be to have good heat control, good heat transfer efficiency, wear resistance and chemical resistance. The injection molding cooling core of the present invention has these characteristics. The materials that would preferably be utilized are urethanes, such as flexible foams, rigid foams and solids. Other materials would be epoxies; phenolics, such as novolacs; amines, such as polyamines; siicones, such as methochlorosilane; composites, such as engineering materials; thermoset polyesters and wood-containing materials; allyls, such as polyester resins derived from esters of allyl alcohol and dibasic acids. Common monomers are allyl diglycol carbonate, also known as diethylene glycol bis (allyl carbonate), diallyl chlorendate, diallyl phthalate, diallyl isophthalate and diallyl maleate.

The present invention is likewise applicable towards the shaping, forming and molding of thermoplastics. In that situation, the tooling should have the desired characteristics of having good thermal control, high-heat transfer efficiency, wear resistance as well as chemical resistance. The injection molding cooling core of the present invention has those characteristics. The most preferred materials that would be formed are thermoplastic materials such a polystyrenics; ABS (acrylonitrile/butadiene/styrene); SAN (styrene/acrylonitrile polymer); polyethylene; polypropylene; polycarbonates; polysulfones; polyethylene terephthalates; polyamides such as nylon and the like; glass materials and metals such as aluminum, aluminum alloys, zinc and zinc alloys, copper, copper alloys, tin and tin alloys.

FIG. 6 schematically illustrates, in a simplified model of an injection molding system, one method of using the injection molding cooling core 10 described in either of the two preferred embodiments. The injection molding cooling core 10 is inserted into a mold 30 having a molding surface 32 so as to define a cavity 34 between the outside surface 17 of the cooling core 10 and the molding surface 32. A material to be molded is injected through the injection port 35 into the cavity 34. A heat exchanging fluid (not shown in this view) is then pumped through the cooling core 10. The molded material will solidify around the cooling core 10 much faster than with conventional cooled molds, thus reducing the cycle time to mold a product.

Some of the advantages of the present invention are: the protrusions provide a greatly increased surface area for the transfer for thermal energy;

the insert (bubbler tube) and its protrusions provide structural support of the (thinned) core pin ball;

the path resistance to the thermal energy flow from the molded part to the heat transfer fluid is minimized due to the structural support of the thinned core pin wall by the insert; and

the heat transfer performance of any such preform tools made of any engineering alloy can be significantly improved using the structural design.

While the forms of the invention herein disclosed constitute presently preferred embodiments, many others are possible. It is not intended herein to mention all of the possible equivalent forms or ramifications of the invention. It is understood that the terms used herein are merely descriptive rather than limiting and that various changes may be made without departing from the spirit or scope of the invention.

We claim:

1. An injection molding cooling core comprising:
an elongated, hollow core pin having an inner surface and an outer surface, the core pin being open at one end, and having an end cap at an opposite end,
an elongated, hollow insert having an inside surface and an outside surface,
the insert having a plurality of protrusions on the outside surface, and extending radially outwardly from the insert,
the insert designed to fit within the core pin whereby the protrusions contact the inner surface of the core pin, and are metallurgically joined to the core pin whereby there is a continuous metallurgical path for heat transfer between the outer surface of the core pin and the insert, and provide strength to the core pin, and
the inside surface of the hollow insert defining a conduit for a heat exchanging fluid, such that the heat exchanging fluid flows in a direction from the open end of the core pin, through the conduit, towards the end cap, exiting the conduit near the end cap and contacting the end cap, then flowing between the outside surface of the insert and the inner surface of the core pin, the heat exchanging fluid further achieving turbulent flow around the protrusions, then flowing out of the open end of the core pin, or the fluid flow is in the opposite direction thus providing heat transfer to or from the outer surface of the core pin.

2. The cooling core of claim 1 wherein the end cap is semi-spherical.

3. The cooling core of claim 1 wherein the protrusions have a curved end designed to maximize the surface area contact between the protrusions and the inner surface of the core pin.

4. The cooling core of claim 1 wherein there are at least four of the protrusions projecting radially outwardly on a plane perpendicular to the axis of the insert, thus forming a row of protrusions, and wherein there is a succession of these rows of protrusions on level planes proceeding down the insert, wherein each succeeding row of protrusions is staggered so that the flow of the heat transfer fluid is caused to go around the protrusions thus enhancing the turbulent flow of the heat transfer fluid as it moves through the core pin.

5. The cooling core of claim 1 wherein there are at least four of the protrusions projecting radially outwardly on a plane perpendicular to the axis of the insert, thus forming a row of protrusions, and wherein there is a succession of rows of protrusions on level planes proceeding down the insert, each succeeding row being rotated at least 30° from the row above, thus enhancing the turbulent flow of the heat transferring fluid.

6. The cooling core of claim 1 wherein the protrusions are on a plane perpendicular to the axis of the insert, thus forming a row of protrusions wherein succeeding rows and each row has a random degree of rotation from each succeeding, thereby providing improved heat transfer performance.

7. The cooling core of claim 1 wherein the core pin and the insert are comprised of any one or a mixture of the following metals: copper beryllium, stainless steel, tool steels, titanium alloys or nickel alloys.

8. The cooling core of claim 1 wherein the core pin and the insert are comprised of a copper beryllium alloy.

9. The cooling core of claim 7 wherein the copper beryllium alloy is comprised of 2% beryllium.

10. The cooling core of claim 4 wherein the four protrusions around the circumference of each row are spaced at an equal distance from each other and each succeeding row is rotated 45° from the row above.

11. An injection molding cooling core comprising:
an elongated, hollow core pin having an inner surface and an outer surface, the core pin being open at one end, and having an end cap at an opposite end,
the core pin having a plurality of protrusions extending radially from the inner surface towards the axis of the core pin,
an elongated, hollow insert having an inside surface and an outside surface,
the protrusions contacting the outside surface of the insert, thus providing strength to the cooling core, and
the inside surface of the hollow insert defining a conduit for a heat exchanging fluid, such that the heat exchanging fluid flows in a direction from the open end of the core pin, through the conduit, towards the end cap, exiting the conduit near the end cap and contacting the end cap, then flowing between the outside surface of the insert and the inner surface of the core pin, the heat exchanging fluid further achieving turbulent flow around the protrusions, then flowing out of the open end of the core pin, or in the opposite direction thus providing heat transfer to or from the outer surface of the core pin.

12. The cooling core of claim 11 wherein the end cap is semi-spherical.

13. The cooling core of claim 11 wherein the protrusions have a curved end designed to increase the surface area contact between the protrusions and the outside surface of the insert.

14. The cooling core of claim 11 wherein the protrusions are on a plane perpendicular to the axis of the insert, thus forming a row of protrusions wherein succeeding rows and each row has a random degree of rotation from each succeeding, thereby providing improved heat transfer performance.

15. The cooling core of claim 11 wherein the core pin and the insert are comprised of any one or a mixture of the following metals: copper beryllium, stainless steel, tool steels, titanium alloys or nickel alloys.

16. The cooling core of claim 11 wherein the core pin comprises a copper beryllium alloy.

17. The cooling core of claim 16 wherein the copper beryllium alloy is comprised of 2% beryllium.

18. The cooling core of claim 11 wherein the insert is comprised of stainless steel.

19. A method of molding a product comprising the steps of:
a) providing a mold having a molding surface,
b) inserting the injection molding cooling core of claim 1 into the mold to define a cavity between the molding surface and the outer surface of the core pin,
c) inserting a material to be molded into the cavity of the mold,
d) molding the product, and
e) recovering the product.

20. The method of claim 19 including the step of circulating a heat transferring liquid through the core immediately after molding the product and prior to recovering the product.

21. The method of claim 19 including the step of circulating a heat transferring liquid through the core immediately before the material to be molded is inserted into the cavity to preheat the core.

22. The method of claim 19 wherein the molded product is a thermoplastic product.

23. The method of claim 22 wherein the thermoplastic product is polyethylene terephthalate (PET).

24. The method of claim 19 wherein the molded product is a thermoset product.

25. The method of claim 19 wherein the molded product is an elastomeric product.

26. A method of molding a product comprising the steps of:
f) providing a mold having a molding surface,
g) inserting the injection molding cooling core of claim 11 into the mold to define a cavity between the molding surface and the outer surface of the core pin,
h) inserting a material to be molded into the cavity of the mold,
i) molding the product, and
j) recovering the product.

27. The method of claim 26 including the step of circulating a heat transferring liquid through the core immediately after molding the product and prior to recovering the product.

28. The method of claim 26 including the step of circulating a heat transferring liquid through the core immediately before the material to be molded is inserted into the cavity.

29. The method of claim 26 wherein the molded product is a thermoplastic product.

30. The method of claim 29 wherein the thermoplastic product is polyethylene terephthalate (PET).

31. The method of claim 25 wherein the molded product is a thermoset product.

32. The method of claim 25 wherein the molded product is an elastomeric product.
